(19) United States
(12) Patent Application Publication
(10) Pub. No.: US 2026/0298374 A1
(43) Pub. Date: Oct. 1, 2026

(54) SET OF DEVICES FOR ROUTING LINES, PIPES, AND/OR CABLES THROUGH A BUILDING COMPONENT

(71) Applicant: Hilti Aktiengesellschaft, Schaan (LI)

(72) Inventors: Brendan Voss, Muenchen (DE); Ulf Mordau, Buchloe (DE); Günter Preschl, Ulm (DE); Nick Mankessi, Erpfting (Landsberg Am Lech) (DE); Anja Belz, Kaufering (DE)

(73) Assignee: Hilti Aktiengesellschaft, Schaan (LI)

(21) Appl. No.: 18/996,619

(22) PCT Filed: Jul. 25, 2023
(86) PCT No.: PCT/EP2023/070603

§ 371 Date: Jan. 17, 2025

(30) Foreign Application Priority Data
Aug. 8, 2022 (EP) 22189222.7

(51) Int. Cl. F16L 5/14; F16L 5/04; H02G 3/06; H02G 3/22

(52) U.S. Cl. CPC F16L 5/14; F16L 5/04; H02G 3/0608; H02G 3/22

(57) ABSTRACT

The invention relates to a set of devices (50) containing at least two devices (1, 52, 53, 54) for performing conduits, pipes and/or cables through a part of a building, each containing a housing having a housing wall, wherein the housing comprises an axial passage channel (6) bounded by the housing wall, extending in the longitudinal direction (L) and having an opening (12) at each of opposite ends (10), wherein the devices (1, 52, 53, 54) have a length (L1, L2, L3) in the longitudinal direction (L) and each have a rectangular cross-section arranged perpendicular to the longitudinal direction (L). The at least two devices (1, 52, 53, 54) each have at least one connection area (72, 74, 76), wherein at least one separate connecting element (70) is provided by means of which the at least two devices (1, 52, 53, 54) can be detachably connected to one another in the connection areas (72, 74, 76).

### TECHNICAL FIELD

The invention relates to a set of devices comprising several devices for routing lines, pipes, and/or cables through building components, such as building walls, building ceilings and the like, and to measures for preventing the passage of fire gases and smoke through such devices.

### TECHNICAL BACKGROUND

During installation, it is customary for several lines, pipes and/or cables to be divided into bundles which are routed by individual devices through building parts. Depending on the use case at hand, the quantities of conduits, pipes and/or cables to be routed through the parts of the building differ in both number and size, so that several devices are provided in one area.

In practice, it is known to combine several identically designed devices in a mounting flange or frame, wherein the devices are connected to one another, for example, via lugs to be bent over arranged on a device.

This type of connection between devices is complex to use and may not be reversible to the desired extent.

It is an object of the present invention to provide a set of devices for performing conduits, pipes and/or cables through a part of a building, by means of which various devices can be reversibly interconnected in a simple manner.

### DISCLOSURE OF THE INVENTION

This object is achieved by the device for routing lines, pipes, and/or cables according to claim 1.

Further embodiments are specified in the dependent claims.

In accordance with one aspect of the invention, there is provided a set of devices comprising at least two devices for performing conduits, pipes and/or cables through a portion of a building, each comprising a housing having a housing wall, wherein the housing has a longitudinally extending axial passageway bounded by the housing wall and each having an opening at opposite ends, wherein the devices have a longitudinal length and each has a rectangular cross-section disposed perpendicular to the longitudinal direction.

According to the invention, it is provided that the at least two devices each have at least one connection area, wherein at least one separate connection element is provided by means of which the at least two devices can be detachably connected to one another in the connection areas.

By means of the at least one connecting element, two devices of the set of devices can be easily connected to each other and disconnected from one another again. The proposed solution is robustly executable, allowing a wide range of connection and disconnection operations without a functional degradation. Preferably, all devices of the set of devices can be connected to one another by means of structurally identical connecting elements.

In a structurally simple embodiment of the invention, the separate connecting element can be connected to the two devices in a clip-like manner. Preferably, the separate connecting element assumes a latched state when connected to two connection areas of two different devices and is thus securely protected against unintentional release. It may be provided that the separate connecting element, in a state connected to two devices, is connected to the connection region of the respective device, said connection region having an undercut.

In an advantageous embodiment of the invention, the separate connecting element has a central receiving region which is provided for the joint enclosure of a wall region of a first device and a wall region of a second device. The receiving region has a thickness here which corresponds substantially to twice the wall thickness of the devices.

In order to ensure a secure connection of the connecting element to two devices, the separate connecting element can have two legs, wherein one leg of the separate connecting element is designed to latch with a device and the other leg of the separate connecting element is designed to latch with another device. During a connection process of the connecting element to two devices, the two legs of the connecting element are pretensioned perpendicularly to an insertion direction of the connecting element in order to latch behind wall regions of the respective devices with end regions of the legs in a completely inserted state. In the completely inserted state, the connecting element again assumes its non-pretensioned or unpretensioned form. As a result, the connecting element is held on the devices counter to a movement counter to the insertion direction.

In an advantageous embodiment of the set of devices, an undesired detachment of the separate connecting element is ensured in that the separate connecting element has at least one region which can be actuated by means of a tool to detach the separate connecting element from the devices.

The separate connecting element preferably has a substantially W-shaped cross section, wherein the separate connecting element is preferably designed with spring steel.

In an advantageous embodiment of a set of devices, the devices have a width in a transverse direction and a height in a vertical direction, wherein a first device has a width, a height, and a length, and a second device has a width, a height, and a length, wherein a ratio of the height of the second device to the height of the first device is n1/x1, wherein n1 and x1 are from the set of natural numbers and are not identical, and/or a ratio of the width of the second device to the width of the first device is n2/x2, wherein n2 and x2 are from the set of natural numbers and are not identical.

Such a design has the advantage that, by providing devices with different cross-sections, it is easy to achieve a degree of loading optimized for the particular use case with a correspondingly high degree of sealing. Furthermore, a total mounting cross section required for an application can be reduced in a simple manner due to the different sizes of the set of devices compared to an embodiment with identically designed devices.

A dimensioning of the devices is selected here in particular in such a way that different devices can be fitted into a frame or mounting flange with a defined height and an optionally variably adjustable width and substantially completely fill a receiving space or an inner cross section of the frame in the mounted state.

In an advantageous embodiment of a set of devices according to the invention, it is provided that a ratio of the second height H2 to the first height H1 is 1:1, 1:2, 1:3, 1:4 or 2:3, and/or that a ratio of the second width B2 to the first width B1 is 1:1, 1:2, 1:3, 1:4 or 2:3. As a result, a passage cross section of a frame can be completely utilized in a simple manner and, at the same time, devices of different sizes can be provided for the respective applications.

It is particularly advantageous if the set of devices is provided with at least one third device with a length, a width and a height, wherein a ratio of the third height to the height of the first device or to the height of the second device is 1:1, 1:2, 1:3, 1:4 or 2:3. Alternatively or additionally, at least one third device with a length, a width and a height can be provided, wherein a ratio of the width of the third device to the width of the first device or to the width of the second device is 1:1, 1:2, 1:3, 1:4 or 2:3. In this case, any number of devices can be provided, wherein at least two but also three or more different dimensionings can be provided. The larger the number of devices with different dimensionings, the more simply a cross-sectional area optimized for the respective application can be achieved.

In an advantageous embodiment of a set of devices, it is provided that at least one device has a square cross section. For example, two devices with different square cross-sections can be used, wherein a height and a width of the small device are preferably ⅓ or ⅔ of a height and a width of a larger device.

Alternatively, devices with a rectangular cross section may also be used, wherein a width-to-height ratio of a device can in principle be selected as desired and the one or more further devices have a height-to-width ratio adapted thereto.

Particularly preferably, the lengths of the devices of the set of devices are substantially identical.

In order to enable a simple attachment of the devices to a wall or a ceiling, the set of devices can have a frame which is provided for attachment to a wall or ceiling and which defines a receiving space or inner cross section which is provided for loading and in which at least two devices can be arranged. The frame can have, for example, a height corresponding to a device or in particular a multiple of the height of a device of the set of devices, for example twice or three times the height of a device. Particularly preferably, the frame is adjustable so that in particular a clear width of the inner cross section of the frame is adjustable. Alternatively or additionally, a clear height of the cross section of the frame for the arrangement of devices may also be adjustable.

In order to enable an advantageous connection of the device, the connection regions of the devices can have a defined distance from a side face, a surface, a lower face, a front face and/or a rear face of the device. In this way, devices with different dimensionings can also be connected to one another in such a way that, in the connected state, at least one face of a device is arranged in alignment with at least one face of the other device.

Preferably, the devices each have at least one first connection region, wherein, in a state in which two devices are connected to one another via an interaction of at least one separate connecting element with the first connection regions, a surface and/or a lower face of the devices are arranged in alignment with one another.

Preferably, the devices have second connection regions, wherein, in a state in which two devices are connected to one another via an interaction of at least one separate connecting element with the second connection regions, at least one side face of the devices are arranged in alignment with one another.

In an advantageous embodiment of a set of devices according to the invention, the devices can have third connection regions, wherein, in a state in which two devices are connected to one another via an interaction of at least one separate connecting element with the third connection regions, two devices are arranged one behind the other in the longitudinal direction. In this way, in particular two devices of substantially identical cross section can be connected to one another and a passage with an increased length can be achieved. A length in the longitudinal direction of the two devices connected in this way to one another can differ from one another.

In an advantageous embodiment of the invention, the separate connecting elements are designed to connect the devices via the first connection regions and the second connection regions and/or the third connection regions. As a result, a single design of connecting element is sufficient to connect different devices to one another in different regions.

Further advantages can be found in the following description of the figures. Embodiments of the present invention are shown in the figures. The figures, the description, and the claims contain numerous features in combination. A person skilled in the art will expediently also consider the features individually and combine them to form further meaningful combinations.

### BRIEF DESCRIPTION OF THE DRAWINGS

Embodiments will be explained in more detail below with reference to the accompanying drawings. In the figures, identical and equivalent components are provided with the same reference signs.

In the drawings:

FIG. 1 is a sectional view of a device for routing lines, pipes, and/or cables through a building part having a passage channel, wherein the device is designed with two parts that can be brought into operative connection with one another, and is shown in an unloaded state in which no line or the like is routed through the device;

FIG. 2 is a sectional view of the device according to FIG. 1, the device being shown in a loaded state with a line routed through the device;

FIG. 3 is a sectional view of part of the device according to FIG. 1 and FIG. 2;

FIG. 4 is a three-dimensional view of a set of devices with four devices in the present case, wherein the device has substantially the structure of the device 1 according to FIG. 1 to FIG. 3, although they may differ from one another with respect to the cross sections;

FIG. 5 is a front view of the set of devices according to FIG. 4;

FIG. 6 is a simplified three-dimensional view of two devices connected to one another in the longitudinal direction;

FIG. 7 is a simplified three-dimensional representation of a frame of the set, wherein different devices can be arranged in an inner cross section of the frame;

FIG. 8 is a simplified three-dimensional view of a connecting element for connecting two devices according to FIG. 1 to FIG. 7;

FIG. 9 is a sectional view of the connecting element according to FIG. 8;

FIG. 10 is a simplified sectional view of a detail of two devices, wherein the connecting element is shown in a state not connected to the devices; and

FIG. 11 is a simplified sectional view of the detail according to FIG. 10, wherein the connecting element is shown in a state connecting the devices to one another.

### DESCRIPTION OF EMBODIMENTS

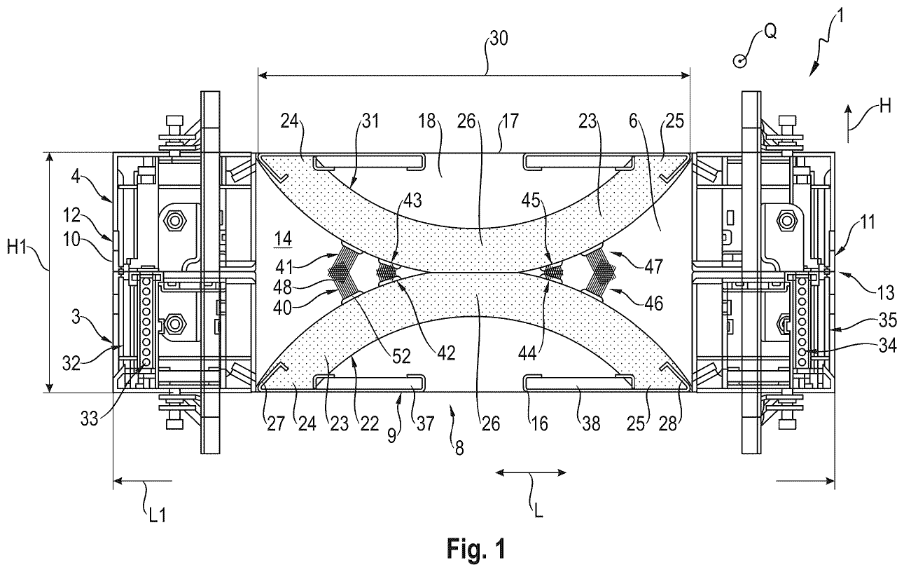

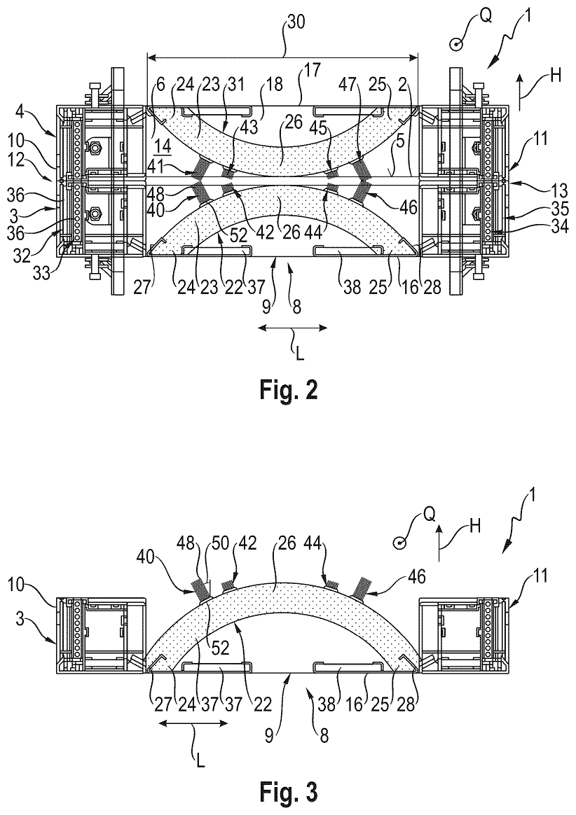

FIG. 1 to FIG. 3 show a device 1 for routing one or more lines, pipes, cables, or the like, such as power lines, water lines, gas lines, and the like, through a building part, such as a building wall, a ceiling, and a floor.

The device 1 does not require any manual opening or closing in order to route lines or the like through the device 1. Rather, these can be routed through the device 1 without further measures.

According to the invention, the device 1 is designed with two parts 3, 4, each having a substantially U-shaped cross section, which parts can be detachably arranged on one another according to FIG. 1. The first part 3 and the second part 4 are substantially identical to one another. In the interconnected state of the parts 3, 4, the device 1 forms an axial passage channel 6 extending in the longitudinal direction L, which passage channel extends from a first axial end 10 to a second axial end 11 and at least in the region of the ends 10, 11 has a continuous opening 12, 13 for lines or the like.

In alternative designs, the device can also be made in one piece.

The device 1 has a housing 8 having a housing wall 9, the housing wall forming the axial passage channel 6 and delimiting an interior space 14 of the device 1. According to the invention, the housing 8 has a substantially rectangular cross section, which in the assembled state of the device 1 is formed by four walls 16, 17, 18. Here, a first wall 16 lies opposite a second wall 17 and extends in a plane spanned by the longitudinal direction L and a transverse direction Q. The further walls 18 formed in each case from a wall piece of the first part 3 and a wall piece of the second part 4 are in turn opposite one another and connect the walls 16 and 17. The further walls 18 extend in a plane spanned by a vertical direction H and the transverse direction Q.

The longitudinal direction L, the vertical direction H and the transverse direction Q are each perpendicular to one another here. A cross section of the device 1 is defined by an extension of the device 1 in the vertical direction H and an extension of the device 1 in the transverse direction Q.

The device 1 has a length L1 in the longitudinal direction L, a width B1 in the transverse direction Q and a height H1 in the vertical direction H, wherein each part 3, 4 here has a height which corresponds to half the height H1. A ratio of the width B1 to the height H1 is, in principle, freely selectable, wherein the width B1 in the present case is approximately twice as large as the height H1. The device 1 accordingly has a rectangular cross section.

Since the first part 3 and the second part 4 are designed to be substantially comparable to one another, the following description of the first part 3 shown in FIG. 3 in isolation is representative of the second part 4.

The first part 3 comprises a first sealing means 22, which is designed here to have a planar foam element 23. The planar foam element 23 is curved transversely to the longitudinal direction L, such that a first end region 24 of the planar foam element 23 and a second end region 25 of the planar foam element 23 that is opposite the first end region 24 are each arranged in the region of the first wall 16. For this purpose, a holding means designed as a holding clip 27 and 28 is provided, by means of which the end regions 24 and 25 of the foam element 23 are secured to the first wall 16. In the assembled state of the device 1, a central region 26 of the foam element 23 arranged between the end regions 24 and 25 extends from the first wall 16 in the direction of the second wall 17 into the interior space 14.

In addition to the embodiment shown with a curved planar foam element, an already preformed foam element may also be used, which can have, for example, a similar curved shape to the foam element 23, or it may be designed to be trapezoidal.

According to the invention, in an extension region 30 of the foam element 23, two intumescent elements 37, 38 are connected to the first wall 16 between the end regions 24 and 25 in the longitudinal direction L, said intumescent elements being intended to ensure closing of the interior 14 in the event of a fire. Alternatively or additionally thereto, further intumescent elements may also be arranged, for example, in the axial end regions 10, 11 of the device 1.

According to the invention, the extension region 30 of the foam element 23 of the first part 3 in the longitudinal direction L corresponds to an extension region 30 of the foam element 23 of the second part 4, such that the common extension region 30 in the longitudinal direction L corresponds to the individual extension regions 30.

In alternative embodiments, the extension regions of the foam elements of the individual parts may differ from one another, a common extension region being defined by an intersection of the extension regions of the individual foam elements in the longitudinal direction L.

As can be seen in simplified form in FIG. 1 to FIG. 3, in each case two sealing arrangements 32, 33, 34, 35 are provided in the region of the axial ends 10, 11 of the device 1, each of which sealing arrangements forms a sealing plane that is perpendicular to the longitudinal direction L and which are each designed having a plurality of directly adjacent, elongate sealing elements 26.

The sealing elements 26 according to the invention have a substantially circular cross section, are designed to be flexible and resilient, and have an extension in their longitudinal direction that is many times greater than the cross section of the sealing elements 26. The sealing elements 26 are designed in this case as resilient lamellae having a plastics fiber made of polypropylene or polyethylene, but in alternative designs they may also be designed as brushes, bristles, strips, bands, tube elements, or the like and may comprise other materials such as metal, rubber, biological materials, or the like.

The sealing elements 26 may also be made with woven fabric, scrims, or paper materials, which are flexible, can be applied snugly to a shell surface of a line or the like routed through the device 1, and, if possible, exert a resilient force on the shell surface in order to ensure the tightest possible seal in the region around the shell surface of the line. The sealing elements 26 may furthermore have an intumescent material and for example be coated with an intumescent material or enclose an intumescent material, and in particular comprise a paper provided with intumescent material.

The sealing elements 26 of the first sealing arrangement 32 extend perpendicularly to the sealing elements 26 of the second sealing arrangement 33. The sealing elements 26 of the third sealing arrangement 34 and fourth sealing arrangement 35 are designed in a similar manner hereto, and are arranged in the region of the second axial end 11 of the device 1.

If a line 2, a pipe, a cable, or the like is routed through the device 1, the sealing elements 26 of the sealing arrangements 32, 33, 34, 35 are curved in such a way that they rest on a shell surface 5 of a line 2 routed through the device 1 and, as a result, seal against the passage of fire gases and smoke and also achieve a certain degree of opaqueness.

In FIGS. 1 to 3, a third sealing means 40, a fifth sealing means 42, a seventh sealing means 44, and a ninth sealing means 46 can also be seen, which are each arranged on the first sealing means 22. Similarly, a fourth sealing means 41, a sixth sealing means 43, an eighth sealing means 45, and a tenth sealing means 47 are arranged on a second sealing means 31 arranged on the second part 4. According to the invention, all sealing means 40 to 47 are arranged completely within the common extension region 30.

The following description of the sealing means 40, 42, 44, 46 assigned to the part 3 is representative of the sealing means 41, 43, 45, 47 assigned to the part 4.

According to the invention, the sealing means 40, 42, 44, 46 each have a plurality of sealing elements 48, which may be designed to be comparable to the sealing elements 36. Preferably, the sealing elements 48 are designed as hairs of a brush, the hairs 48 of the brush in particular having a common longitudinal extension direction in the unloaded state of the device 1. According to the invention, the longitudinal extension direction of the hairs is not perpendicular to the longitudinal direction L of the device 1, but rather encloses an angle 50 together with a transverse plane Q that is transverse to the longitudinal direction L, which angle may be, for example, between 0° and 45°, for example approximately 30°.

The hairs 48 of the brushes are each arranged on a holding element 52, by means of which the brushes are arranged, in particular glued, directly on the first foam element 23. According to the invention, the third sealing means 40 and the fifth sealing means 42 are arranged on a side of the central region 26 of the foam element 23 facing the first opening 12 of the device 1 and the seventh sealing means 44 and the ninth sealing means 46 are arranged on a side of the central region 26 of the foam element 23 facing the second opening 13 of the device 1. A length of the sealing elements 48 of the fifth sealing means 42 and of the seventh sealing means 44, which are arranged closer to the central region 26 of the foam element 23 than the third sealing means 40 and the ninth sealing means 46, is shorter than the length of the sealing elements 48 of the third sealing means 40 and of the ninth sealing means 46.

In the assembled state of the unloaded device 1, the sealing elements 48 of the cooperating sealing means 40 to 47 of the first part 3 and of the second part 4 engage in a comb-like manner. In alternative embodiments, the end regions of the sealing elements of the cooperating sealing means may also stand flush with one another in the unloaded state of the device 1.

As can be seen in more detail in FIG. 1, sealing elements 48 of the sealing means 40 to 47 that cooperate with one another in the unloaded state of the device 1 engage in one another in a comb-like manner. In addition, the central regions 26 of the foam elements 23 adjoin one another over a particular extension region in the longitudinal direction L of the device 1, such that good gas tightness is achieved in the unloaded state of the device 1.

In the loaded state according to FIG. 3, in addition to the sealing arrangements 32 to 35, sealing is also provided in the region of the foam elements 23 and in the region of the sealing means 40 to 47 with respect to the line 2 routed through the device 1 and passage of gas is reliably prevented or passage of gas is greatly reduced.

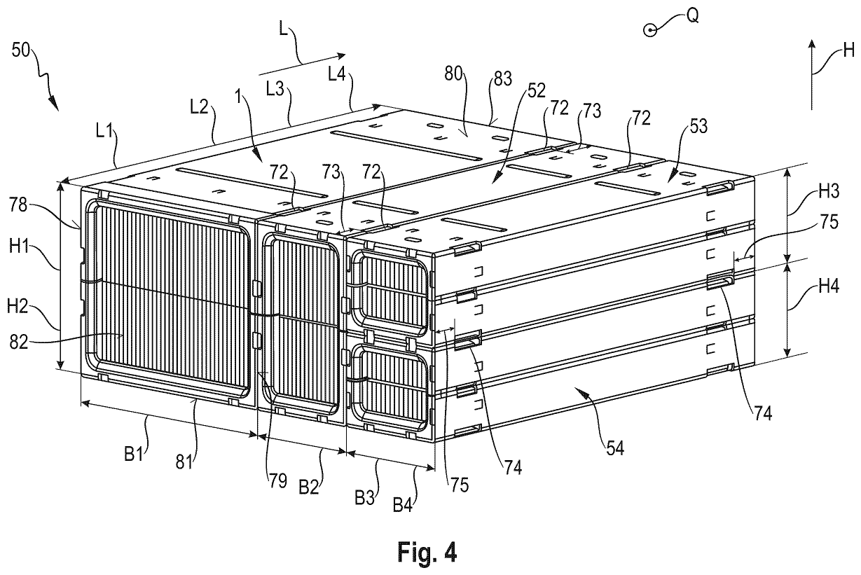

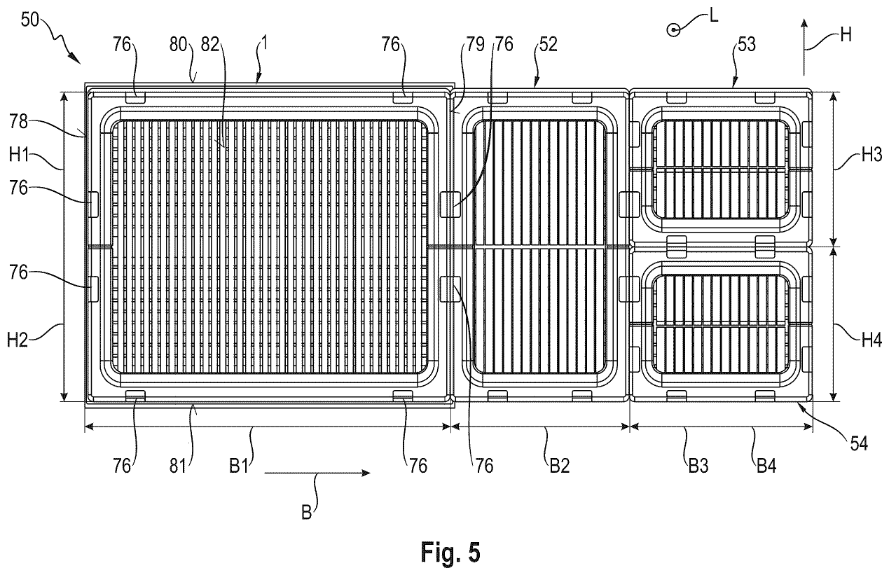

FIG. 4 shows a set of devices 50, which in the present case is designed with four devices 1, 52, 53, 54. The set of devices 50 furthermore has a frame 56 or wall flange, wherein the devices 1, 52, 53, 54 can be arranged in an inner cross section 58 or receiving space defined by the frame 56. The inner cross section 58 of the frame 56 is optionally flexibly adjustable so that, for example, a width 60 of the inner cross section 58 in the transverse direction Q and/or a height 62 of the inner cross section 58 in the vertical direction H can be variably adjusted. At least two differently dimensioned devices 1, 52, 53, 54 can be arranged in the inner cross section 58 of the frame 56.

In particular, two frames 56 are provided in order to be able to arrange the devices 1, 52, 53, 54 in a simple manner on both sides of a building part, in particular a wall or a ceiling.

According to the embodiment according to FIG. 4, the set of devices 50 in the present case has three differently dimensioned devices 1, 52, 53 and 54, wherein the devices 53 and 54 have the same cross section in the present case.

In the present case, the device 52 has a height H2 in the vertical direction, which corresponds to the height H1 of the device 1. In the present case, a width B2 of the device 52 corresponds to half of the width B1 of the device 1, wherein the width B2 can in principle assume any desired value deviating from the width B1 of the device 1. In the present case, the length L2 of the device 52 is substantially identical to the length L1 of the device 1.

The devices 53, 54 have a length L3 which likewise corresponds to the length L1 of the device 1. In the present case, a width B3 of the devices 53, 54 corresponds to the width B2 of the device 52 and thus corresponds to half of the width B1 of the device 1. In the present case, a height H3 of the devices 53, 54 corresponds to half of the height H1 of the device 1 or half of the height H2 of the device 52. An arrangement of the two devices 53 and 54 in the vertical direction H one above the other thus has a height H1 or H2 corresponding to the devices 1 and 52.

Particularly preferably, the set of devices has devices whose heights H1 substantially correspond to a whole number divisor of the height 62 of the inner cross section 58 so that an arrangement of a corresponding number of devices in the vertical direction H one above the other fills the entire height 62 of the inner cross section 58.

In addition to the embodiment of devices having a rectangular cross section, devices with a square cross section can also be used in principle in the set of devices.

Particularly preferred cross-sectional ratios of devices of a set of devices are listed in the following tables:

TABLE 1
Size ratios of devices with a cross section that is in particular rectangular

| | Dimensioning 1 | Dimensioning 2 | Dimensioning 3 | Dimensioning 4 | Dimensioning 5 |
|---|---|---|---|---|---|
| Width | B | B/2 | B/2 | B/4 | B/4 |
| Height | H | H | H/2 | H/2 | H/4 |

TABLE 2
Size ratios of devices with a cross section that is in particular square

| | Dimensioning 1 | Dimensioning 2 | Dimensioning 3 |
|---|---|---|---|
| Width | B = H | 2B/3 | B/3 |
| Height | H = B | 2H/3 | H/3 |

In principle, it may be provided that the set of devices also has only two differently dimensioned devices and the devices differ in their structure. Furthermore, the set of devices may also have a larger number of differently dimensioned devices.

A number of devices with the same dimensions can also be freely selected in principle so that, for example, all devices have different dimensionings or extents. A number of devices with the same dimensions can be selected as desired so that each device can be used once, twice, three or multiple times.

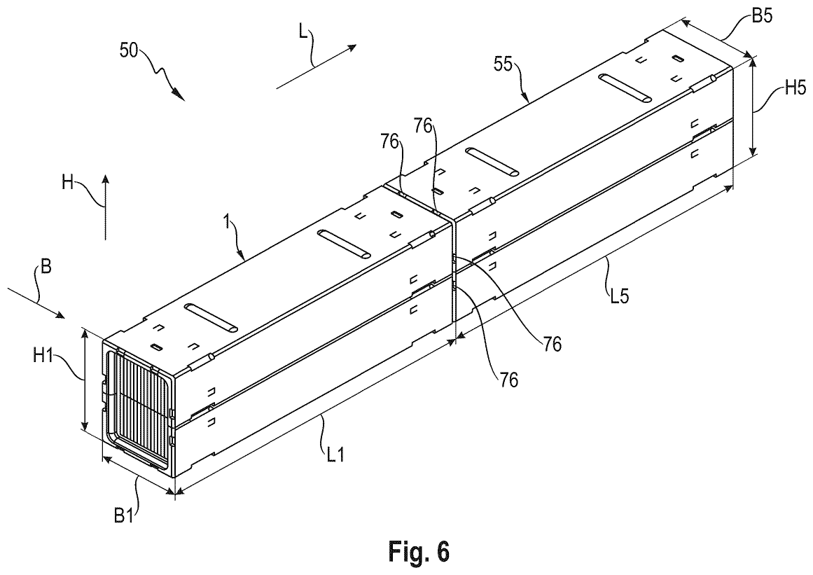

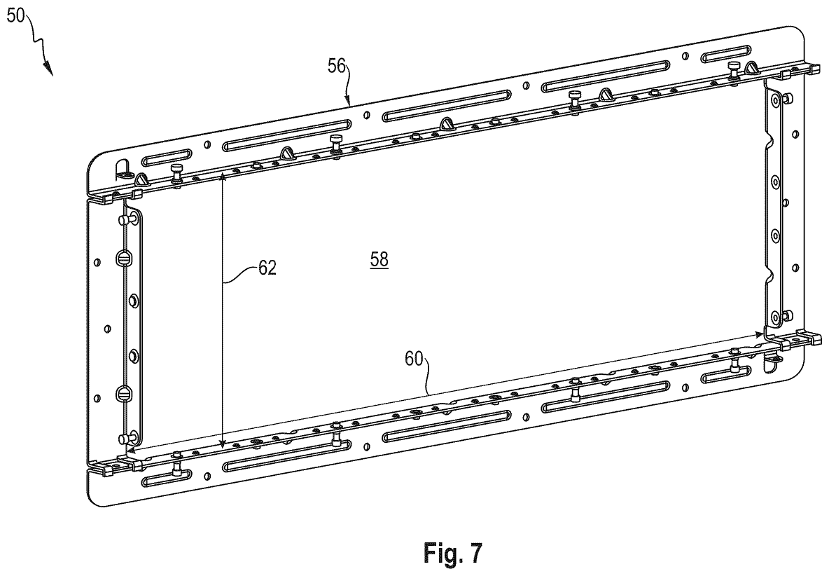

In addition to the arrangement of different devices 1, 52, 53, 54 in the transverse direction Q and/or vertical direction H next to one another, it may also be provided that different devices 1, 52, 53, 54 are arranged one behind the other in the longitudinal direction L. Devices having a substantially identical cross section are used here. In FIG. 6, for example, the arrangement of two devices 1 and 55 one behind the other in the longitudinal direction L is shown, the device 55 substantially corresponding to the device 1.

Alternatively, it may also be provided that the device 55 substantially corresponds to the structure of the device 1 but has a length L4 which deviates from the length L1. The length L4 may, for example, correspond to half the length L1. In principle, the length L4 of the device 55 may assume any value in relation to the length L1 of the device 1.

The devices 1, 52, 53, 54, 55 each have two side faces 78 and 79 which point in the transverse direction and each of which borders a surface 80 and a lower face 81.

In the present case, each device 1, 52, 53, 54, 55 has first connection regions 72, second connection regions 74 and third connection regions 76, with two devices 1, 52, 53, 54, 55 being detachably connectable to one another via connecting elements 70 described in greater detail later. The first connection regions 72 are provided for connecting two devices 1, 52, 53, 54, 55 in the transverse direction Q via an interaction by means of one or more connecting elements 70. Two devices 1, 52, 53, 54, 55 can be connected to one another by means of one or more connecting elements 70 in the vertical direction H via the second connection regions 74. Lastly, two devices 1, 52, 53, 54, 55 can be detachably connected to one another in the longitudinal direction L via an interaction of at least one connecting element with the third connection regions 76.

The devices 1, 52, 53, 54, 55 can each have one or more, in particular two or preferably four connection regions 72, 74, 76, via which two devices 1, 52, 53, 54, 55 can be detachably connected to one another in the transverse direction Q, in the vertical direction H or in the longitudinal direction L by means of one or more connecting elements 70.

In the present case, it is provided that similar devices 1, 52, 53, 54, 55 and also differently dimensioned devices 1, 52, 53, 54, 55 can be detachably connected to one another in the transverse direction Q, in the vertical direction H and in the longitudinal direction L by means of identically designed connecting elements 70, wherein devices 1, 52, 53, 54, 55 to be connected to one another in the longitudinal direction L in particular have a substantially identical cross section.

In order to connect two devices 1, 52, 53, 54, 55 in the transverse direction Q, the devices 1, 52, 53, 54, 55 in the present case each have two first connection regions 72 in a transition region of a side face 78 or 79 to the surface 80 and to the lower face 81 so that each device has eight first connection regions 72 in the present case. A distance 73 of first connection regions 72 assigned to the first axial end 10 from the first axial end 10 and a distance 73 of first connection regions 72 assigned to the second axial end 11 from the second axial end 11 is in the present case substantially identical for all first connection regions 72 and in the present case also substantially identical in all devices 1, 52, 53, 54, 55.

As can be seen in part in FIG. 4, for example, the device 1 and the device 52 can be detachably connected to one another via four connecting elements 70 which interact with corresponding first connection regions 72. In the present case, two connecting elements 70 in the region of surfaces 80 and two connecting elements 70 in the region of lower faces 81 interact with the devices 1 and 52. In the connected state, surfaces 80 and lower faces 81 of the devices 1 and 52 are arranged substantially in alignment with one another.

In order to connect two devices 1, 52, 53, 54, 55 in the vertical direction H, the devices 1, 52, 53, 54, 55 in the present case each have two second connection regions 74 in a transition region of a side face 78 or 79 to the surface 80 and to the lower face 81 so that each device 1, 52, 53, 54, 55 has eight first connection regions 74 in the present case. A distance 75 of second connection regions 74 assigned to the first axial end 10 from the first axial end 10 and a distance 75 of second connection regions 74 assigned to the second axial end 11 from the second axial end 11 is in the present case substantially identical for all second connection regions 74 and in the present case also substantially identical in all devices 1, 52, 53, 54, 55.

In the present case, the first connection regions 72 and the second connection regions 74 are each formed by material recesses in the housing wall 9 of the devices 1, 52, 53, 54, 55, wherein the first connection regions 72 and the second connection regions 74 are formed by identical material recesses and are thus arranged in identical regions of the devices 1, 52, 53, 54, 55.

As can be seen in greater detail in part in FIG. 4, the device 53 and the device 54 are, for example, detachably connectable to one another via four connecting elements 70 which interact with corresponding second connection regions 74. In the present case, two connecting elements 70 interact with the devices 53 and 54 in the region of each side face 78 and 79. In the connected state, side faces 78 and 79 of the devices 53 and 54 are arranged substantially in alignment with one another.

In order to connect two devices 1, 52, 53, 54, 55 in the longitudinal direction L, as can be seen for example in FIG. 6, eight third connection regions 76 are provided in the region of each axial end 10 or 11 in the present case. Two third connection regions 76 are in each case arranged in a transition region of a side face 78 or 79, of the surface 80 or of the lower face 81 to a front face 82 or a rear face 83 of the device 1, 52, 53, 54, 55. Two devices 1, 52, 53, 54, 55 connected to one another in the longitudinal direction L in particular have a substantially identical cross section, wherein all third connection regions 76 are in particular provided at identical positions.

The third connection regions 76 are also formed here in a manner comparable to the first connection regions 72 and the second connection regions 74, in each case by material recesses in the housing wall 9 of the devices 1, 52, 53, 54, 55.

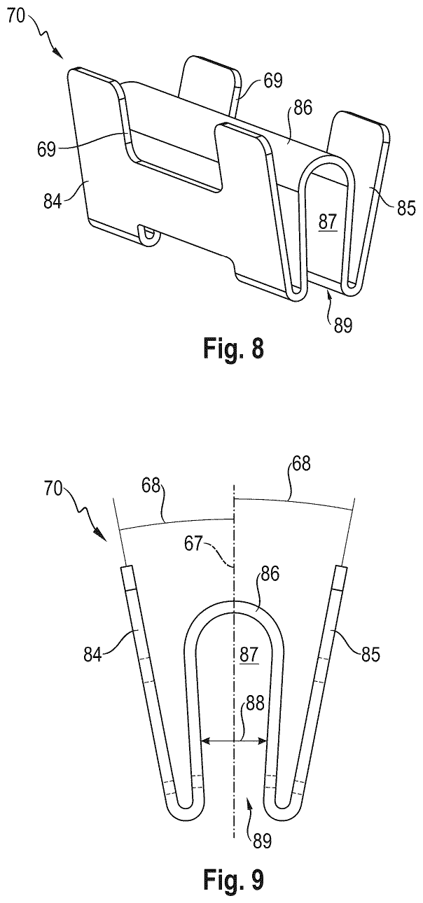

The connecting element 70 shown in isolation in FIG. 8 and FIG. 9 has a W-shaped cross section. A lateral leg 84 or 85 is in each case connected here resiliently to a central region 86 which is U-shaped in cross section and forms a receiving region 89. The legs 84, 85 each have an angle 68 of, for example, approximately 20° to a central axis 67 of the connecting element 70. The central U-shaped region 86 forms a recess 87 with a width 88.

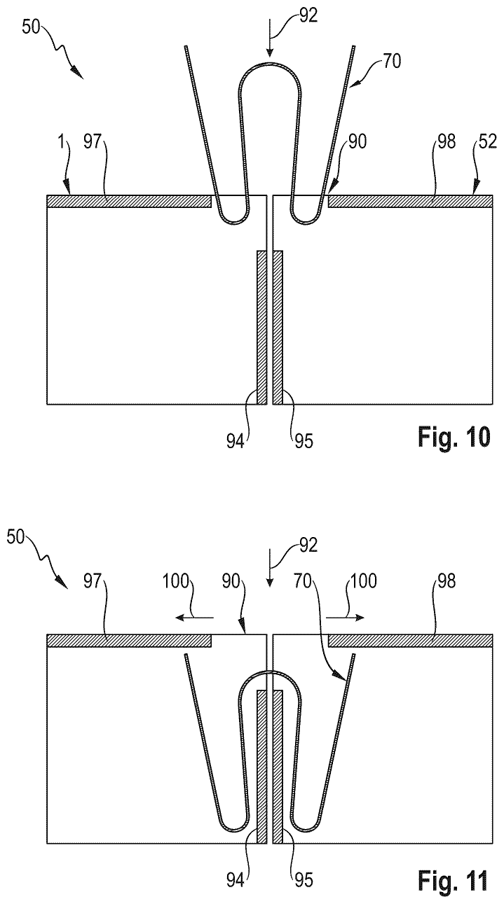

In FIG. 10 and FIG. 11, a first connection region 72 of the device 1 and a first connection region 72 of the device 52 are shown in a highly simplified manner by way of example, via which the devices 1 and 52 can be detachably connected to one another in the transverse direction Q. It can be seen here that with a corresponding orientation of the devices 1 and 52 with respect to one another, the devices 1 and 52 form an insertion opening 90 for the connecting element 70, by means of which insertion opening the connecting element 70 can be inserted completely in the longitudinal direction L into the region of the devices 1 and 52 starting from the intermediate state in FIG. 8 in an insertion direction 92. In the state according to FIG. 11, which connects the devices 1 and 52 to one another, the U-shaped region 86 of the connecting element 70 comprises a first wall region 94 of the device 1 and a first wall region 95 of the device 52. The legs 84 and 85 are pretensioned during the insertion process and relax in the completely inserted process in such a way that the legs 84 and 85 prevent a movement of the connecting element 70 against the insertion direction 92 through a corresponding undercut in walls of the devices 1 and 52. The connecting element 70 thus does not protrude beyond an outer surface of the devices 1 and 52 in the state connected to the devices 1 and 52.

In the state shown in FIG. 11, the connecting element 70 is shown in a latched state, in which the devices 1 and 52 are connected to one another by the connecting element 70 and unintentional detachment of the connecting element 70 is reliably prevented.

In the region of each leg 84 and 85, the connecting element 70 has a recess 69, via which the connecting element 70 can be moved, for example, by an engagement of a tool from the latched state according to FIG. 11 into a state in which the connecting element 70 is detachable from the devices 1 and 52 counter to the insertion direction 90.

Via the second wall regions 97 and 98 shown in FIG. 10 and FIG. 11, the devices 1 and 52 can be connected via connecting elements 70 in the vertical direction H to further devices 1, 52, 53, 54, 55, wherein a connecting element 70 is in engagement with the respective devices 1, 52, 53, 54, 55 in the insertion direction 100 for this purpose.

1. A set of devices comprising:
at least two devices for performing conduits, pipes and/or cables through a part of a building, each having a housing with a housing wall,
wherein the housing has an axial passage channel which is bounded by the housing wall, extends in the longitudinal direction and has an opening at opposite ends in each case,
wherein the devices have a length in the longitudinal direction and each having a rectangular cross section arranged perpendicular to the longitudinal direction,
wherein the at least two devices each have at least one connection area, wherein at least one separate connecting element is provided by which the at least two devices can be releasably connected to one another in the connection areas.

2. The set of devices according to claim 1, wherein the separate connecting element is connectable to the two devices in a clip-like manner.

3. The set of devices according to claim 1, wherein the separate connecting element has a central receiving area which is provided for jointly enclosing a wall area of a first device and a wall area of a second device.

4. The set of devices according to claim 1, wherein the separate connecting element has two legs, wherein one leg at a time is adapted to latch to a device.

5. The set of devices according to claim 1, wherein the separate connecting element has at least one area operable by a tool for detaching the separate connecting element from the devices.

6. The set of devices according to claim 1, wherein the separate connecting element has a substantially W-shaped cross-section.

7. The set of devices according to claim 1, wherein the devices have a width in a transverse direction and a height in an upward direction, wherein a first device has a width, a height and a length, and a second device has a width, a height and a length, wherein a ratio of the height of the second device to the height of the first device is n1/x1, where n1 and x1 are from the set of natural numbers and are not identical, and/or a ratio of the width of the second device to the width of the first device is n2/x2, wherein n2 and x2 are from the set of natural numbers and are not identical.

8. The set of devices according to claim 7, wherein a ratio of the height of the second device to the height of the first device is 1/1, ½, ⅓, ¼ or ⅔.

9. The set of devices according to claim 7, wherein a ratio of the width of the second device to the width of the first device is 1/1, ½, ⅓, ¼ or ⅔.

10. The set of devices according to claim 7, wherein at least one third device having a length, a width and a height is provided, wherein a ratio of the height of the third device to the height of the first device or to the height of the second device is 1/1, ½, ⅓, ¼ or ⅔.

11. The set of devices according to claim 10, wherein at least one third device having a length, a width and a height is provided, wherein a ratio of the width of the third device to the width of the first device or to the width of the second device is 1/1, ½, ⅓, ¼ or ⅔.

12. The set of devices according to claim 1, wherein at least one device has a square cross section.

13. The set of devices according to any of the preceding claims claim 1, characterized in that wherein the lengths of the devices are substantially identical.

14. The set of devices according to any of the preceding claims claim 1, characterized in that wherein a frame is provided, which is provided for attachment to a wall or ceiling and defines a receiving space which is provided for loading and in which at least two devices can be arranged.
